(19) United States
(12) Patent Application Publication
(10) Pub. No.: US 2005/0214085 A1
(43) Pub. Date: Sep. 29, 2005

(54) Portable adjustable support for drill

(76) Inventor: Frank Owens, Crescent City, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/089,343

(22) Filed: Mar. 24, 2005

Related U.S. Application Data
(60) Provisional application No. 60/556,579, filed on Mar. 26, 2004.

(51) Int. Cl. B23B 47/00

(52) U.S. Cl. 408/136

(57) ABSTRACT

A portable drill support having a force transfer assembly that comprises a pair of parallel linear segments joined in a hinged manner that allows the relative position of the segments to be varied while still maintaining their parallel relationship. The segments are joined by a pivoting swing hinge member and a pivoting handle member, the handle member being the leveraging arm used to apply force to the drill. The force assembly is joined to either an extension assembly, preferably composed of detachable extension segments, or a forward bracing assembly that comprises a hook member. Preferably the drill mount, the extension assembly and the forward bracing assembly are connected by mechanical interlocking means that allow the apparatus to be disassembled.

This application claims the benefit of U.S. Provisional Patent Application Ser. No. 60/556,579, filed Mar. 26, 2004, the disclosure of which is incorporated herein by reference.

### BACKGROUND OF THE INVENTION

This invention relates generally to the field of drill presses, drill supports or other apparatuses used for supporting portable drills during the drilling operation and that assist the drill operator in applying forward force. More particularly, the invention relates to such apparatuses that support the drill during use in both vertical and horizontal positions.

Large-scale construction projects, such as buildings, office towers, bridges and the like, typically require thousands, hundreds of thousands and even millions of holes to be drilled in various structural components. In order to drill into steel beams, concrete beams, concrete walls, concrete slabs, steel plates and the like, heavy-duty portable drills are required. The drill operator must apply significant forward force during the drilling operation into these hard substances. This is relatively easily accomplished when the holes are to be drilled beneath the operator, such as down into a floor slab or a horizontal beam, but is more difficult when the holes are to be drilled into vertical surfaces or overhead surfaces. Holes drilled in the upper portions of vertical surfaces or in overhead surfaces require the operator to mount a ladder with the heavy drill, drill the hole, dismount and move the ladder to the next location for drilling, re-mount the ladder, etc. Drilling multiple holes in this manner is a tiring and slow process.

Supporting or leveraging apparatuses have been developed to assist in the drilling operation. Examples of such apparatuses are seen for example in U.S. Pat. No. 628,404 to Forrester, U.S. Pat. No. 2,571,862 to Glenn, U.S. Pat. No. 2,720,125 to Palik, U.S. Pat. No. 2,879,677 to Baublitz, U.S. Pat. No. 2,947,204 to Pine et al., U.S. Pat. No. 3,552,239 to Yeaman et al., U.S. Pat. No. 4,442,905 to Agoston, U.S. Pat. No. 5,322,397 to Spear, U.S. Pat. No. 6,095,724 to Hurt, and U.S. Pat. No. 6,264,407 to Tinken. While attempting to address the problems described above, all of these known apparatuses suffer drawbacks in one area or another.

It is an object of this invention to provide an apparatus that supports a portable drill and allows the operator to apply leverage to the portable drill, whether the drill is being used in the horizontal or vertical direction. It is a further object to provide such an apparatus that enables the operator to brace the drill against a fixed structure to the rear of the drill, against the operator himself, or against the far side of the structure being drilled. It is a further object to provide such an apparatus that provides easy application of force in a leveraged manner. It is a further object to provide such an apparatus that allows the operator to apply forward force to the drill with either a pushing motion or a pulling motion on a handle. It is a further object to provide such an apparatus that is lightweight and able to be disassembled for transport and storage.

### SUMMARY OF THE INVENTION

The invention is in general a portable adjustable support for a portable drill, the support serving to brace the drill in either the horizontal or vertical direction against an opposing fixed structure, against the operator himself or against the far side of the object being drilled depending on the chosen assembly configuration of the multiple components of the support apparatus. The support allows forward force to be applied to the drill through either a pushing motion or a pulling motion utilizing a pivoting handle. The support is most preferably able to be disassembled into components for easy storage and transport.

The apparatus comprises in general a drill mount means to receive a portable hand-held electric drill in an affixed manner. The drill mount means is preferably designed to be a universal mount able to securely receive drills of differing manufacture and shape, in a manner that permits access to the actuation trigger and other drill operating features. The drill mount means is joined to a force transfer assembly that comprises a pair of parallel linear segments joined in a hinged manner that allows the relative position of the segments to be varied while still maintaining their parallel relationship. The segments are connected by the combination of a pivoting swing hinge member and a pivoting handle member, the handle member being the leveraging arm used to apply force to the drill. The force transfer assembly is joined to either an elongated extension assembly, preferably composed of detachable extension segments, or a forward bracing assembly that comprises a hook member. Preferably the drill mount means, the extension assembly and the forward bracing assembly are connected by mechanical interlocking means that allow the apparatus to be disassembled and the overall length of the apparatus to be varied.

### BRIEF DESCRIPTION OF THE DRAWINGS

FIG. 1 is an expanded view showing the apparatus in operational mode utilizing the extension assembly.

FIG. 2 is an expanded view showing the apparatus in operation mode utilizing the forward bracing assembly.

### DETAILED DESCRIPTION OF THE INVENTION

With reference to the drawings, the invention will now be described in detail with regard for the best mode and the preferred embodiment. In a broad sense, the invention is a portable adjustable support for a portable drill, the support serving to brace the drill in either the horizontal or vertical direction against an opposing fixed structure, against the operator himself or against the far side of the object being drilled. The support is structured to receive portable drills of many standard configurations. The support allows forward force to be applied to the drill through either a pushing motion or a pulling motion utilizing a pivoting handle. The support is most preferably able to be disassembled into components for easy storage and transport.

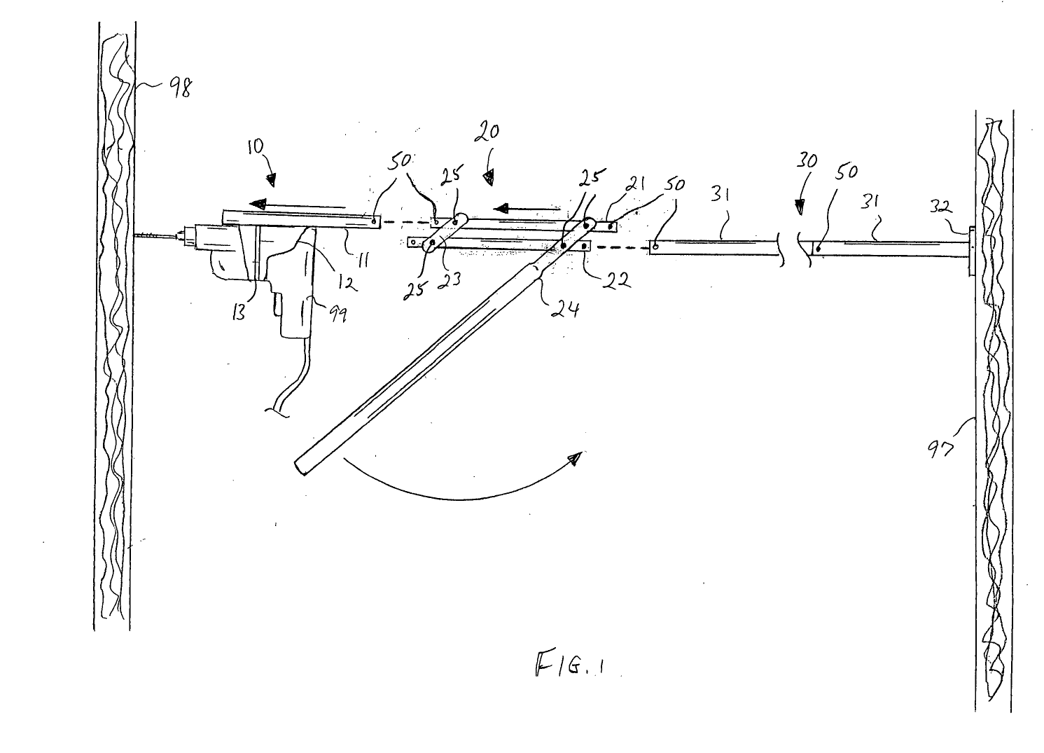

FIG. 1 illustrates the apparatus of the invention as assembled to be used when an opposing bracing member 97 is present for supporting the apparatus and the drill 99 in order to drill a hole in a fixed workpiece 98. The orientation of the figure is arbitrary in that the workpiece 98 and bracing member 97 may be vertically or horizontally oriented. For example, when drilling a generally horizontal hole in a workpiece 98 consisting of a vertical beam member, a wall or the like, the apparatus is braced against another fixed vertical member serving as bracing member 97. When drilling upwardly into the underside of a workpiece 98 consisting of a floor slab, horizontal beam or the like, then bracing member 97 consists of a floor slab, lower horizontal beam or similar horizontal member. A drill mount means 10 receives a portable electrical drill 99 or similar tool in any suitable manner, either permanently or temporarily in a manner that allows the drill 99 to be removed if desired such that different drills 99 may be used with the apparatus. Drill mount means 10 may be structured as part of the drill 99, as an integral one-piece member to receive a drill 99, or may be composed of multiple components such as a mounting arm member 11 joined to a drill bracket or sleeve member 12 that envelops the drill 99. A tightening strap member 13 may be utilized to better secure the drill 99 relative to the drill bracket 12. The mounting arm 11 is adapted to be attachable to a force transfer assembly 20.

Force transfer assembly 20 comprises a first segment 21 and a second segment 22 disposed in parallel alignment. The first segment 21 and second segment 22 are each adapted to independently receive the drill mounting arm 11 of the drill mount means 10 in detachable manner through mechanical interlocking means 50. Preferably, first segment 21, second segment 22 and drill mounting arm 11 are tubular elements structured to be joined by insertion of one end of one member into the end of another member, the diameters of the ends being sized to accomplish this joining. The interlocking means 50 may further comprise spring-biased detents that correspond to detent-receiving apertures. Alternatively, the segments 21 and 22 and the drill mounting arm 11 may be joined by interlocking means 50 comprising threaded couplings or other suitable mechanisms.

The first segment 21 and second segment 22 are joined in a hinged manner such that relative motion between the two segments 21 and 22 is possible, with both segments 21 and 22 remaining in parallel disposition through all position changes. This movement is accomplished by pivotally attaching a swing hinge member 23 and a handle or leveraging arm member 24 to both segments 21 and 22, preferably at, adjacent or near the ends of segments 21 and 22. Swing hinge member 23 preferably comprises a pair of short, generally flat segments mounted on opposite sides of the first and second segments 21 and 22 by pins 25 or the like. Handle member 24 is likewise mounted to the first and second segments 21 and 22, and is of significantly greater length than swing hinge member 23. Handle member 24 is mounted parallel to the swing hinge member 23. Handle member 24 may comprise multiple joined parts. In this manner first segment 21 can be advanced by movement of handle member 24 to extend forward beyond second segment 22 or retracted such that second segment 22 extends forward beyond first segment 21, with corresponding results to the rear of force transfer assembly 20. During relative advancement or retraction, the first and second segments 21 and 22 remain in parallel disposition. The extended length of handle member 24 allows greater leveraging force to be applied to drill 99 during the drilling operation.

Extension assembly 30, preferably constructed of material similar to the first and second segments 21 and 22 and mounting arm 11, such as aluminum, PVC or similar tubing, is detachably joined to either the first segment 21 or second segment 22 of force transfer assembly 20 using mechanical interlocking means 50. Extension assembly 30 preferably comprises a foot member 32 having an area of increased surface area for dispersion of energy against the bracing member 97, and may be provided with a high friction or padded surface to preclude slipping. Extension assembly 30 is most preferably constructed to comprise multiple extension segments 31 detachably joined to each other by mechanical interlocking means 50 such that the overall length of the apparatus can be varied and further such that the extension assembly 30 can be disassembled into shorter lengths for storage or transport. This may be accomplished, for example, by providing end portions of reduced or expanded diameter such that two segments 31 are joined in telescoping manner to provide variations in overall length of the extension assembly 30.

The apparatus utilizing the extension assembly 30 can be assembled in alternative configurations depending on whether it is desirable to use a forward pushing motion or a backward pulling motion on handle member 24 to advance the drill 99. To utilize a pulling motion, the drill mounting arm 11 is joined to the forward end of first segment 21 on force transfer assembly 20, the segment on the opposite side from the direction the handle member 24 extends, and the extension assembly 30 is joined to the rear end of second segment 22 on force transfer assembly 20. With the apparatus braced against the opposing bracing member 97, pulling the handle member 24 rearward advances the first segment 21, the drill mount means 10 and the drill 99 into the workpiece 98, as shown in FIG. 1. Alternatively, the apparatus can be assembled such that the handle member 24 is pushed forward to advance the drill 99 by joining the drill mounting arm 11 to the forward end of the second segment 24, the segment on the same side as the extended handle member 24, and joining the extension assembly 30 to the rear of the first segment 21.

It is also possible for the operator himself to act as the bracing member 97, such that the foot member 32 of extension assembly 30, or the hook member 42 of forward bracing assembly 40 in a rear mounting position, may be supported upon the operator's shoulder or received within a belt-mounted holder. Preferably, a contoured pad is provided for better force dissipation where the operator supports the assembly with his shoulder.

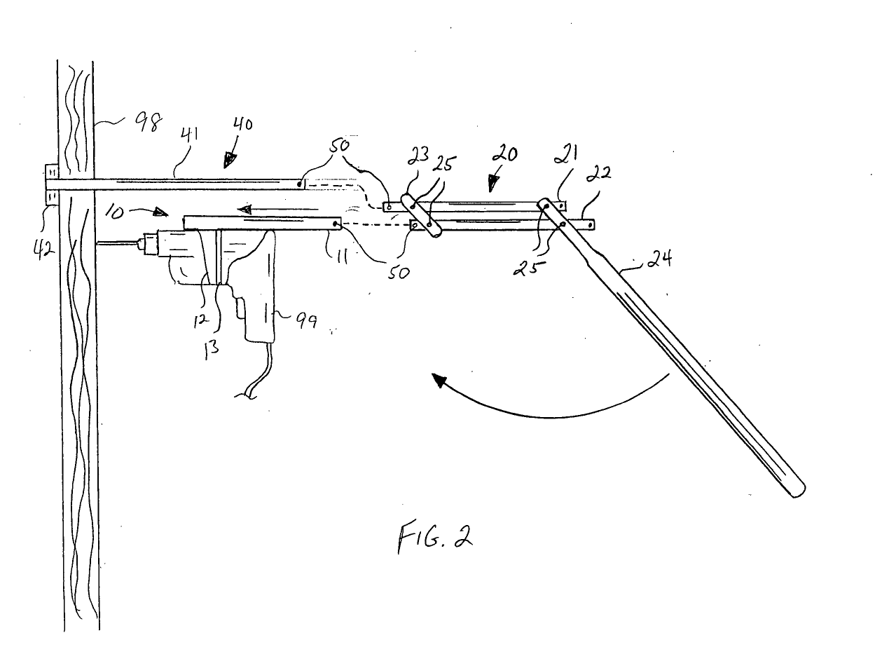

Assembling the apparatus using the forward bracing assembly 40 instead of the extension assembly 30 allows the invention to be utilized as shown in FIG. 2, such that the bracing and leveraging is based on the workpiece 98 itself and the drill 99 is in effect pulled toward the workpiece 98. As with FIG. 1, the orientation of FIG. 2 is arbitrary in that the workpiece 98 and bracing member 97 may be vertically or horizontally oriented. Forward bracing assembly 40, which may be of unitary or segmented construction in similar manner to extension assembly 30, comprises an elongated bracing segment 41, preferably constructed of similar material to that of extension assembly 30, and a hook member 42. Hook member 42 may take various shapes, but comprises a flange, arm or similar component connected to the forward end of bracing segment 41 at a generally right angle such that the majority of the hook member 42 body extends laterally from bracing segment 41. Hook member 41 may be provided with a high friction or padded surface to prevent slipping. Alternatively, the foot member 32 of the extension assembly 30 may be structured in a hook-like configuration such that the extension assembly 30 may also function as the forward bracing assembly 40 without the need for separate components.

The rear end of bracing segment 41 is attached by mechanical interlocking means 50 to the forward end of second segment 22 of force transfer assembly 30, with the drill mount means 10 attached to the forward end of first segment 21. The hook member 42 is disposed on the opposite or far side of the workpiece 98 being drilled. With the forward bracing assembly 40 attached to the second segment 22 and the drill 99 attached to the first segment 21, pulling the handle means 24 backward results in advancement of the drill 99. Alternatively, with the forward bracing assembly 40 attached to the first segment 21 and the drill 99 attached to the second segment 22, pushing the handle means 24 forward results in advancement of the drill 99, as shown in FIG. 2.

Thus, the invention provides a portable adjustable drill support that can be utilized to drill horizontal or upwardly vertical holes in fixed objects, where the weight of the drill 99 is supported by the apparatus and where the apparatus provides a leveraging means to magnify force supplied by the operator. It is understood that equivalents and substitutions for elements set forth above may be obvious to those skilled in the art, and therefore the true scope and definition of the invention is to be as set forth in the following claims.

1. A drill support apparatus comprising:
a portable drill;
a drill mount means to receive said drill;
a force transfer assembly comprising a first segment and a second segment disposed in parallel relation, a swing hinge and a leveraging handle member, said swing hinge and said handle member each pivotally joined to both said first segment and said second segment such that movement of said handle member results in movement of at least one of said first and second segments relative to each other; and
an extension assembly;
wherein said drill is mounted to said drill mount means, said drill mount means is detachably joined to either said first segment or said second segment of said force transfer assembly, and said extension assembly is detachably joined to either said first segment or said second segment of said force transfer assembly;
whereby with said drill mount means joined to said first segment and said extension assembly joined to said second segment opposite from said drill means, movement of said handle member away from said drill causes said drill to be advanced; and
whereby with said drill mount means joined to said second segment and said extension assembly joined to said first segment opposite from said drill means, movement of said handle member toward said drill causes said drill to be advanced.

2. The apparatus of claim 1, wherein said drill mount means detachably receives said drill.

3. The apparatus of claim 1, wherein said drill mount means comprises a mounting arm.

4. The apparatus of claim 1, wherein said first segment and said second segment of said force transfer assembly are tubular members.

5. The apparatus of claim 1, wherein said extension assembly comprises plural extension segments such that the length of said extension assembly is variable.

6. The apparatus of claim 4, wherein said extension assembly comprises tubular extension segments.

7. The apparatus of claim 1, whereby with said drill mount means joined to said first segment and said extension assembly joined to said second segment on the same side as said drill means, movement of said handle member away from said drill causes said drill to be advanced; and
whereby with said drill mount means joined to said second segment and said extension assembly joined to said first segment on the same side as said drill means, movement of said handle member toward said drill causes said drill to be advanced.

8. The apparatus of claim 7, said extension assembly further comprising a foot member.

9. The apparatus of claim 1, further comprising a forward bracing assembly, wherein said forward bracing assembly is detachably joined to either said first segment or said second segment of said force transfer assembly;
whereby with said drill mount means joined to said first segment and said forward bracing assembly joined to said second segment on the same side as said drill means, movement of said handle member away from said drill causes said drill to be advanced; and
whereby with said drill mount means joined to said second segment and said forward bracing assembly joined to said first segment on the same side as said drill means, movement of said handle member toward said drill causes said drill to be advanced.

10. The apparatus of claim 9, said forward bracing assembly comprising a hook member.

11. A support apparatus for a portable drill comprising
drill mount means to receive a drill;
a force transfer assembly;
an extension assembly; and
a forward bracing assembly;
wherein said force transfer assembly comprises a first segment and a second segment joined in hinged manner and a handle member, such that the relative positions of said first and second segments are variable with said first and second segments disposed parallel to each other through any change in relative position;
wherein said drill mount means is joined to said force transfer assembly; and
wherein one of said extension assembly and said forward bracing assembly is joined to said force transfer assembly, with said extension assembly being joined to said force transfer assembly opposite from said drill mount means, and with said forward bracing assembly being joined to said force transfer assembly on the same side as said drill mount means.

12. The apparatus of claim 11, wherein said drill mount means detachably receives said drill.

13. The apparatus of claim 1, wherein said drill mount means comprises a mounting arm.

14. The apparatus of claim 11, wherein said first segment and said second segment of said force transfer assembly are tubular members.

15. The apparatus of claim 11, wherein said extension assembly comprises plural extension segments such that the length of said extension assembly is variable.

16. The apparatus of claim 14, wherein said extension assembly comprises tubular extension segments.

17. The apparatus of claim 1, whereby with said drill mount means joined to said first segment and said extension assembly joined to said second segment, movement of said handle member away from said drill causes said drill to be advanced; and
whereby with said drill mount means joined to said second segment and said extension assembly joined to said first segment, movement of said handle member toward said drill causes said drill to be advanced; and
whereby with said drill mount means joined to said first segment and said forward bracing assembly joined to said second segment, movement of said handle member away from said drill causes said drill to be advanced; and
whereby with said drill mount means joined to said second segment and said forward bracing assembly joined to said first segment, movement of said handle member toward said drill causes said drill to be advanced.

18. The apparatus of claim 11, said extension assembly further comprising a foot member.

19. The apparatus of claim 11, said forward bracing assembly comprising a hook member.
